(19) United States
(12) Patent Application Publication
(10) Pub. No.: US 2024/0409373 A1
(43) Pub. Date: Dec. 12, 2024

(54) HORIZONTAL REVOLVING GATE

(71) Applicant: Universal City Studios LLC, Universal City, CA (US)

(72) Inventor: Christopher Erickson, Mendham, NJ (US)

(21) Appl. No.: 18/621,007

(22) Filed: Mar. 28, 2024

Related U.S. Application Data
(60) Provisional application No. 63/618,088, filed on Jan. 5, 2024.
(60) Provisional application No. 63/472,214, filed on Jun. 9, 2023.

(51) Int. Cl. B66B 29/08; A63J 19/00; B66B 21/10; B66B 25/00; E05C 17/02; E05C 17/56; E06B 11/02

(52) U.S. Cl. CPC B66B 29/08; B66B 21/10; B66B 25/003; E05C 17/02; E05C 17/56; E06B 11/027; A63J 19/00

(57) ABSTRACT

A show-ride attraction includes a moving pathway configured to transport a guest toward a barrier, and a gate positioned across the moving pathway upstream of the barrier relative to a direction of travel of the moving pathway, wherein the gate is configured to transition between a first position and a second position in response to the guest engaging with the gate. The ride-show attraction further includes one or more sensors configured to detect transitioning of the gate from the first position to the second position, and a controller configured to control the moving pathway in response to an indication from the one or more sensors that the gate is transitioning and/or has transitioned to the second position.

### CROSS-REFERENCE TO RELATED APPLICATIONS

This application claims priority to and the benefit of U.S. Provisional Application No. 63/618,088, filed Jan. 5, 2024, entitled “HORIZONTAL REVOLVING GATE,” and U.S. Provisional Application No. 63/472,214, filed Jun. 9, 2023, entitled “HORIZONTAL REVOLVING GATE,” each of which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Since the early twentieth century, amusement parks have substantially grown in popularity, and an increasing amount of people visit amusement park attractions. Further, an increasing number of amusement park attractions have utilized show-ride entertainments systems that provide various immersive experiences to guests within the amusement park. The show-ride entertainment systems may employ movable walkways and paths configured to receive one or more of the guests within the amusement park and transport the guests through the show-ride entertainment system. Further, the show-ride entertainment systems may provide visual, audio, and/or haptic feedback to guests on the moving walkways or paths to provide an immersive experience to guests within the park. It is now recognized that it may be desirable to incorporate additional components into show-ride systems having moving walkways or paths to provide additional services and features, thereby improving a guest experience within the amusement park.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a show-ride attraction includes a moving pathway configured to transport a guest toward a barrier, and a gate positioned across the moving pathway upstream of the barrier relative to a direction of travel of the moving pathway, wherein the gate is configured to transition between a first position and a second position in response to the guest engaging with the gate. The ride-show attraction further includes one or more sensors configured to detect transitioning of the gate from the first position to the second position, and a controller configured to control the moving pathway in response to an indication from the one or more sensors that the gate is transitioning and/or has transitioned to the second position.

In another embodiment, a non-transitory, computer-readable medium includes computer-executable instructions that, when executed by processing circuitry, cause the processing circuitry to operate a moving pathway at a first speed to transport guests from an entry point of a show-ride attraction to an exit point of the show-ride attraction, to receive sensor data from one or more sensors positioned about the show-ride attraction, wherein the sensor data is indicative of a gate of the show-ride attraction transitioning from a first position to a second position, and to operate the moving pathway at a second speed to facilitate departure of a guest from the moving pathway based on the sensor data indicating that the gate is in the second position.

In another embodiment, a method for controlling operation of a moving pathway of a show-ride attraction includes initiating operation of the moving pathway to transport one or more guests from an entry point of the show-ride attraction to an exit point of the show-ride attraction, receiving sensor data from one or more sensors, where the sensor data is indicative of at least one of the one or more guests interacting with a gate extending across the moving pathway such that the gate transitions from a first position to a second position, and controlling a speed of the moving pathway based on the sensor data indicating that the gate is in the second position.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and context of embodiments of the present disclosure without limitation to the claimed subject matter.

### BRIEF DESCRIPTION OF THE DRAWINGS

FIG. 1 is a schematic view of an embodiment of a show-ride system of an amusement park, in accordance with embodiments of the present disclosure;

FIG. 2 is a perspective view of an embodiment of a gate employed by a show-ride system, in accordance with embodiments of the present disclosure;

FIG. 3 is a rear perspective view of an embodiment of a gate transitioning from a normal operating position to a disengaged position, in accordance with embodiments of the present disclosure;

FIG. 4 is a side view of an embodiment of a latch system employed by the gate of FIG. 1, in accordance with embodiments of the present disclosure.

FIG. 5A is a side view of an embodiment of the latch system of FIG. 4 in the normal operating position, in accordance with embodiments of the present disclosure;

FIG. 5B is a side view of an embodiment of the latch system of FIG. 4 in a disengaged position, in accordance with embodiments of the present disclosure;

FIG. 5C is a side view of an embodiment of the latch system of FIG. 4 in a disengaged position, in accordance with embodiments of the present disclosure;

FIG. 5D is a side view of an embodiment of the latch system of FIG. 4 in a fully disengaged position, in accordance with embodiments of the present disclosure;

FIG. 6 is a schematic view of an embodiment of a magnet system employed by the gate of FIG. 1, in accordance with embodiments of the present disclosure;

FIG. 7 is a perspective view of an embodiment of a sensor mounting plate, in accordance with embodiments of the present disclosure;

FIG. 8 is a perspective view of an embodiment of a mounting bracket, in accordance with embodiments of the present disclosure; and

FIG. 9 is a flow diagram of an embodiment of a method for controlling the show-ride system of FIG. 1, in accordance with embodiments of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to the field of amusement parks and more specifically to show-ride entertainment systems within amusement parks. Show-ride entertainment systems may employ a number of different components to provide an experience for guests within an amusement park. For example, the show-ride entertainment system may employ one or more moving pathways (e.g., moving walkways, travelator) that are configured to receive one or more guests within the park and carry or transport the guests along a pre-defined path through the show-ride attraction. The show-ride system may also include show action equipment disposed along the pre-defined pathway to provide an immersive experience to guests transported through the show-ride system via the moving pathways. For example, the show-ride system may include show action equipment and/or show structures (e.g., displays, props, etc.) that provide guests with an experience (e.g., visual, audio, and/or haptic feedback) as the guests are transported via the moving pathways. Guests may enter the moving pathways at an entry point, and the moving pathway may transport the guest through the show-ride attraction toward an exit point. In some cases, a barrier (e.g., a wall) may be located proximate the exit point, thereby blocking guests from being transported beyond the exit point as the walkway continues to travel beneath the barrier. However, due to the moving nature of the moving pathways, it may be difficult for certain guests to properly exit the moving pathway prior to the moving pathway traveling beneath the barrier or wall.

Accordingly, present embodiments are directed to a show-ride system that employs a revolving gate (e.g., swing gate, horizontally revolving gate) disposed proximate the exit point. The revolving gate may employ at least two operational states: (1) a normal operating position, wherein a portion of the gate is loosely secured in an operational configuration and (2) a disengaged position, wherein the portion of the gate is dislodged from the secured position and allowed to rotate into a disengaged configuration. Indeed, the revolving gate may be configured to revolve or rotate about a rotation position (e.g., axis (e.g., fixed axis), point (e.g., fixed point)) between the normal operating position (e.g., closed position) and a fully extended orientation of the disengaged position (e.g., open position) in response to a guest engaging with the gate. Thus, a bottom portion of the gate is enabled to move along an axis defined by the moving pathway in the disengaged position (e.g., move in a direction toward the barrier). The show-ride system may also employ one or more sensors configured to detect transitioning of the gate from the normal operating position to the disengaged position (e.g., in response to a guest engaging with the gate), and a controller configured to instruct the moving pathway to slow and/or stop in response to receiving a signal from the one or more sensors indicative of the gate transitioning to the disengaged position (e.g., indicative of a guest engaging with the gate). In this way, the difficulty associated with exiting the show-ride attraction may be reduced, thereby improving a guest's experience associated with the show-ride attraction.

As may be appreciated, implementations of the present disclosure may be embodied as a system, method, device, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer-readable program code embodied thereon.

Computer program instructions, in accordance with present embodiments, may be stored in a computer readable medium (e.g., hard drive, memory, disk) that can direct a computer, other programmable data processing apparatus, or other devices to function in a particular manner, such that the instructions stored in the computer readable medium initiate or cause a specified function/act. The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

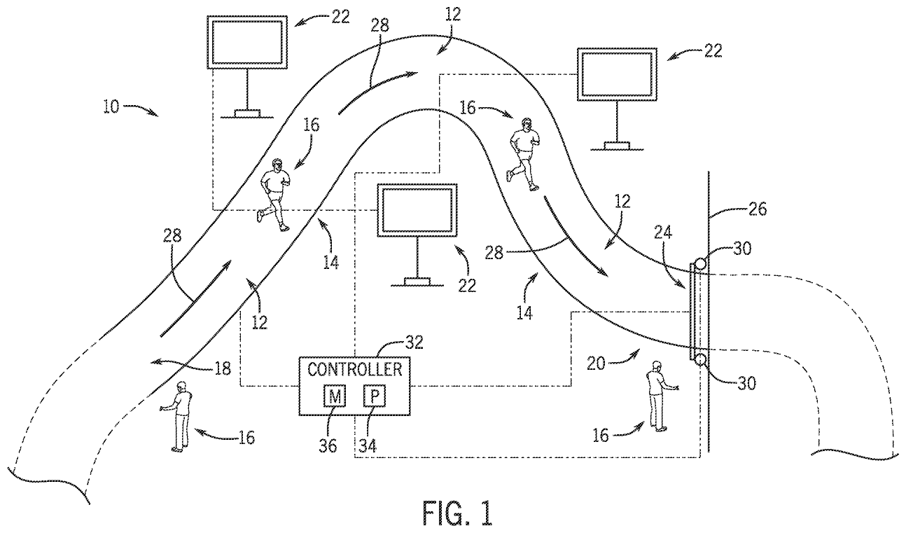

With the preceding in mind, FIG. 1 is a schematic view of a show-ride system 10 (e.g., show-ride attraction), in accordance with embodiments discussed herein. As illustrated, the show-ride system 10 includes a pathway 12 (e.g., moving pathway, moving walkway, travellator) configured to traverse a pre-defined path 14 through the show-ride system 10. The pathway 12 may be configured to transport or carry guests 16 from an entry point 18 to an exit point 20 of the show-ride system 10, thereby enabling the guests 16 to receive visual and/or audio feedback from components of the show-ride system 10. The show-ride system 10 may also include show action equipment 22 configured to provide visual, audio, and/or haptic feedback for guests 16 transported along the pathway 12. In certain embodiments, the show action equipment 22 may include one or more show structures (e.g., animated figures, characters, screens, moving objects) that are configured to provide an immersive experience to guests positioned along the pathway 12.

In the illustrated embodiment, the show-ride system 10 includes a gate 24 (e.g., revolving gate, horizontal revolving gate) positioned proximate the exit point 20. The gate 24 may be positioned upstream of a barrier 26 relative to a direction of travel 28 of the pathway 12, and the gate 24 may be configured to block guests 16 from being transported beyond the exit point 20 as the pathway 12 continues to travel beneath the barrier 26. In an embodiment, the gate 24 itself may designate an ending of the pathway 12 (e.g., without a separate barrier). In certain embodiments, the gate 24 may be configured to transition between two operational states: (1) a normal operating position, in which a portion of the gate is loosely secured to a frame of the gate 24 and (2) a disengaged position, in which the portion of the gate 24 is dislodged from the secured position and allowed to rotate. Indeed, the gate 24 may be configured to revolve or rotate about a rotation position (e.g., axis (e.g., fixed axis), point (e.g., fixed point)) between the normal operating position (e.g., closed position) and a fully extended orientation of the disengaged position (e.g., open position) in response to a guest engaging with the gate 24.

The show-ride system 10 may also employ one or more sensors 30 which may be coupled (e.g., mounted) to a component of the show-ride system 10 (e.g., the gate 24 (e.g., a frame of the gate 24), a wall, show-action equipment 22) via a sensor mounting bracket, as discussed in greater detail below. In certain embodiments, the one or more sensors 30 may include motion sensors, proximity switches, pressure sensors, radar sensors, impact sensors, camera sensors, or any combination thereof. The one or more sensors 30 may be configured to detect transitioning of the gate 24 from the normal operating position to the disengaged position and/or configured to detect engagement of a guest 16 or object associated with the guest 16 with the gate 24. Additionally, in certain embodiments, the one or more sensors 30 may be configured to collect data indicative of one or more characteristics of a guest 16 positioned along the pathway 12, and such data may further be used to control aspects of the show-ride system 10, as discussed in greater detail below.

For example, during operation of the show-ride system 10, the pathway 12 may direct guests toward the exit point 20 and toward the gate 24. In the event that a guest 16 is unable to timely depart from the pathway 12, a portion (e.g., a body part, leg, foot) of and/or a component (e.g., a wheelchair, purse, backpack) associated with the guest 16 may engage with the gate 24 while the gate 24 is oriented in the normal operating position. In turn, as the guest 16 or component of the guest 16 engages with the gate 24, the gate 24 may transition to the disengaged position in a direction toward the barrier 26, and movement of the gate 24 may be detected by the one or more sensors 30 associated with the gate 24. As discussed herein, engagement and/or interaction of the gate 24 by a guest 16 may refer to a guest engaging and/or interacting with the gate 24 such that a side of the gate 24 moves downstream of the gate 24 relative to the direction of travel 28 of the pathway 12 (e.g., toward the barrier 26 disposed downstream of the gate 24 in FIG. 1). Thus, contact between a guest 16 and a handrail of the gate 24 may not be referred to as engagement of the gate 24 by the guest 16, as discussed in greater detail below.

The one or more sensors 30 may be configured to send signals indicative of a guest 16 and/or component of the guest 16 engaging with the gate 24 to a controller, thereby enabling the controller to control operation of the show-ride system 10 (e.g., control operation of the pathway 12, control operation of the show action equipment 22). For example, in certain embodiments, certain components of the show-ride system 10 discussed above (e.g., the pathway 12, the show action equipment 22, the gate 24, the sensors 30) may be communicatively coupled to a controller 32 configured to control operation of the show-ride system 10 (e.g., control a speed of the pathway 12). The controller 32 may include a distributed control system or any computer-based system that is fully or partially automated. For example, the controller 32 may include a processor that may include processing circuitry 34 (e.g., a microprocessor(s)) that may execute instructions (e.g., software programs, algorithms, executable code) to perform the disclosed techniques. Moreover, the processor 34 may include multiple microprocessors, one or more “general-purpose” microprocessors, one or more special-purpose microprocessors, and/or one or more application specific integrated circuits (ASICS), or some combination thereof. The controller 32 may also include a memory device 36 for storing instructions executable by the processing circuitry 34. Data stored on the memory device 36 may include, but is not limited to, algorithms for operation of the pathway 12, the show action equipment 22, and/or the gate 24.

Upon receiving sensor data from the one or more sensors 30 indicative of a guest 16 and/or component of the guest 16 engaging with the gate 24, the controller 32 may be configured to instruct the pathway 12 to slow and/or stop, thereby enabling a guest 16 to depart from the pathway 12 or extract an object from the pathway 12 in an easier manner relative to when the pathway 12 is in motion. That is, upon the gate 24 transitioning from the normal operating position to the disengaged position (in response to a guest engaging the gate 24), the controller 32 may be configured to instruct the pathway 12 to slow and/or stop or halt, thereby enabling guests 16 positioned on the pathway 12 to depart from the show-ride system 10. In an embodiment, the actuation of the gate 24 may include levels of actuation or analog actuation such that varying levels of actuation trigger different responses. For example, full actuation may result is a shutdown whereas partial actuation may result is slowed operations, as discussed in greater detail below.

In certain embodiments, the one or more sensors 30 may be configured to collect data indicative of a magnitude of and/or quantity of engagement and/or interaction of a guest 16 and/or component of the guest with the gate 24, thereby enabling the controller 32 to control operation of the pathway 12. Additionally, in certain embodiments, the one or more sensors 30 may be configured to collect data indicative of one or more characteristics (e.g., age, gender, family size, components and/or objects associated with the guest) of the guests 16 disposed along the pathway 12, and the controller 32 may utilize such data to further control operation of the pathway 12. That is, the controller 32 may utilize various factors and analyze data from multiple different sensors 30 disposed about the show-ride system 10, thereby enabling the controller 32 to control operation of the pathway 12, as discussed in greater detail below.

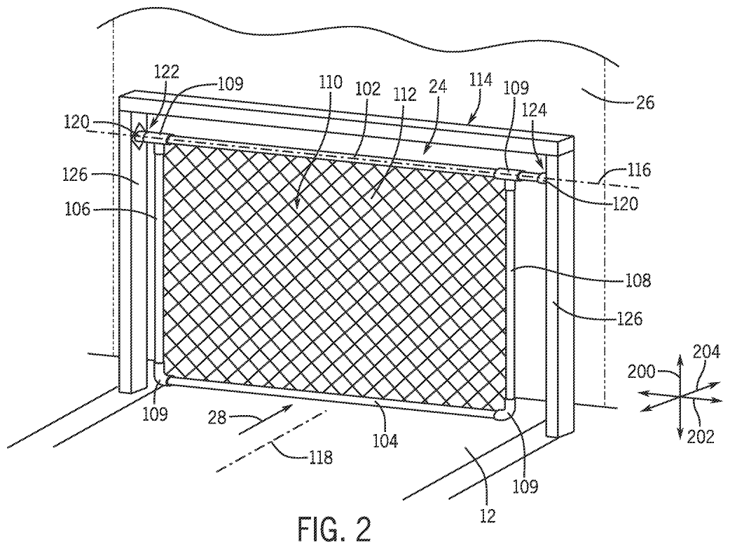

FIG. 2 is a perspective view of an embodiment of the gate 24 of FIG. 1. In the illustrated embodiment, the gate 24 is oriented along a vertical axis 200, a lateral axis 202, and a longitudinal axis 204 and is positioned upstream of the barrier 26 relative to the direction of travel 28 of the pathway 12. The gate 24 includes a first side 102 (e.g., top side, handrail, axis of rotation, first rail, fixed side) extending in a direction (e.g., horizontal direction) along the lateral axis 202, a second side 104 (e.g., bottom side, base, second rail, free side) opposite the first side 102 and extending in a direction (e.g., horizontal direction) along the lateral axis 202, a third side 106 (e.g., first lateral side, first lateral rail) extending in a direction (e.g., vertical direction) along the vertical axis 200 from the first side 102 to the second side 104, and a fourth side 108 (e.g., second lateral side, second lateral rail) opposite the third side 106 and extending in a direction (e.g., vertical direction) along the vertical axis 200 from the first side 102 to the second side 104. In certain embodiments, the sides 102, 104, 106, 108 of the gate 24 may be coupled to one another via connectors 109. However, in other embodiments, each of the sides 102, 104, 106, 108 of the gate 24 may be formed from a single piece of material such that the connector(s) 109 may be omitted.

Each of the sides 102, 104, 106, 108 of the gate 24 may collectively define an opening 110 (e.g., cavity) of the gate 24, and in certain embodiments, a barrier 112 (e.g., a net, a fence, chain links) may extend across the opening 110 to limit a guest 16 (or object associated with the guest 16) from traveling beyond the gate 24 (e.g., into the barrier 26). For example, in certain embodiments, the barrier 116 may correspond to a net disposed across the opening 110 and configured to limit a guest 16 and/or object associated with the guest 16 from traveling beyond the gate 24 (e.g., into the barrier 26). It should be appreciated that while each of the sides 102, 104, 106, 108 define the opening 110 of the gate 24, in certain embodiments, the gate 24 may be formed from a solid piece of material such that each of the sides 102, 104, 106, 108 collectively define a first surface (e.g., a front surface, upstream surface relative to the direction of travel 28 of the pathway 12) of the gate 24 and a second surface (e.g., back surface, rear surface, downstream surface relative to the direction of travel 28 of the pathway 12) of the gate 24.

As noted above, the gate 24 may be configured to transition from the normal operating position to the disengaged position in response to a guest 16 and/or component of the guest 16 engaging with a portion of the gate 24 (e.g., a guest engaging with the barrier 112, engaging with a surface and/or a side 104, 106, 108 of the gate 24 such that the gate 24 transitions from the normal operating position to the disengaged position). To this end, the first side 102 of the gate 24 may be rotatably coupled to a frame 114 such that the gate 24 may rotate about a rotation position 116 (e.g., axis, fixed axis, axis defined by the first side 102, point, fixed point) relative to the frame 114 to transition the gate 24 between the normal operating position and the disengaged position. That is, the first side 102 of the gate 24 may be fixed relative to the frame 114, thereby enabling the gate 24 to rotate about the rotation position 116.

At least one of the other sides 104, 106, 108 of the gate 24 may be loosely coupled to the frame 114 and may be configured to disengage from the frame based on a guest 16 and/or component of the guest 16 interacting and/or engaging with the gate 24. As discussed herein, “loosely coupled,” “loosely engaged,” and/or “a loose coupling” may refer to a coupling that may be disengaged or uncoupled (e.g., in one or more directions) in response to a directional force, such as vector of force applied by a guest interacting with a component of the gate 24. For example, the second side 104 of the gate 24 may be a distal end (e.g., free end) of the gate 24 that is loosely coupled (e.g., loosely engaged) with the frame 114 via one or more couplers (e.g., magnets, pins, latches), as discussed in greater detail below. Upon a guest 16 interacting and/or engaging with the gate 24, the couplers may disengage from one another and the second side 104 of the gate 24 may translate (e.g., move) along an axis 118 defined by the pathway 12 (e.g., in a direction along the longitudinal axis 204). That is, the second side 104 of the gate 24 may be configured to move in a direction toward the barrier 26 disposed downstream of the gate 24 relative to the direction of travel 28 of the pathway 12 along the axis 118 (e.g., move in the direction of travel 28 of the pathway 12 proximate the exit point 20 along the longitudinal axis 204) when rotated about the rotation position 116 (e.g., axis defined by the first side 102).

In certain embodiments, the gate 24 may be coupled to the frame 114 via one or more mounting brackets 120. For example, the first side 102 of the gate 24 may include a first end 122 and a second end 124. A first mounting bracket 120 may be coupled to a first support 126 (e.g., first vertical support) of the frame 114 and a second mounting bracket 120 may be coupled to a second support 126 (e.g., second vertical support) of the frame 114. Each mounting bracket 120 may include a cavity configured to receive a respective first end 122 or second end 124 of the first side 102 of the gate 24. Thus, as noted above, the first side 102 of the gate 24 may be fixed relative to the frame 114. In this way, the gate 24 may rotate about the rotation position 116 defined by the first side 102 (e.g., the second side 104 of the gate 24 may move toward or away from the barrier 26 in a direction along the axis 118 defined by the pathway 12). In certain embodiments, the first side 102 of the gate 24 may also serve as a handrail for guests 16 departing from the pathway 12. For example, because the first side 102 is fixed relative to the frame 114, guests 16 exiting the pathway 12 may utilize the first side 102 to facilitate departure from the pathway 12 without transitioning the gate 24 to the disengaged position.

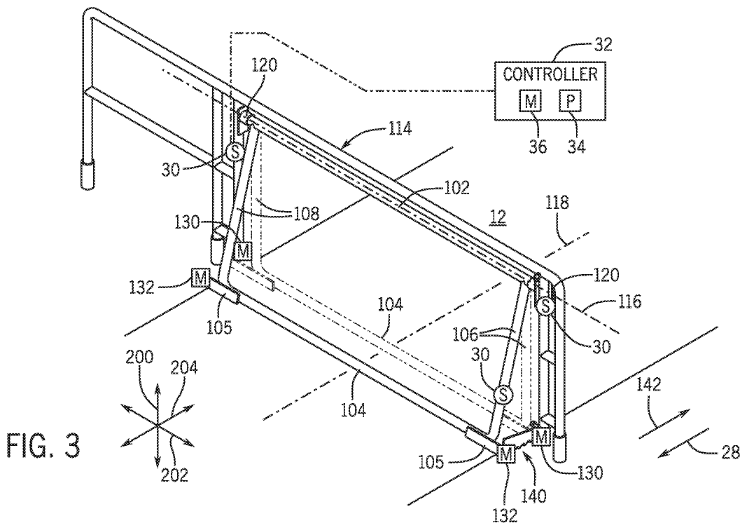

As noted above, in certain embodiments, the gate 24 may be configured to transition between a normal operating position (e.g., secured position) in which the gate 24 is loosely engaged with the frame 114, and a disengaged position, in which a portion of the gate 24 (e.g., the second side 104) is dislodged from the secured position and allowed to move toward or away from the barrier 26 along the axis 118 defined by the pathway 12. To this end, the gate 24 may include couplers (e.g., one or more magnets, latches, pins) configured to loosely secure the gate 24 to the frame 114 (e.g., when the gate 24 is in the normal operating position). For example, FIG. 3 illustrates a rear perspective view of an embodiment of the gate 24 transitioning from the normal operating position to the disengaged position. In the illustrated embodiment, the second side 104 includes one or more extensions 105 extending from the second side 104 in a direction (e.g., horizontal direction) along the lateral axis 202. In certain embodiments, each of the extensions 105 may extend (e.g., in a horizontal direction along the lateral axis 202) beyond a lateral boundary of the gate 24, thereby enabling the extensions 105 to overlap with features and/or components of the frame 114 along the longitudinal axis 204, thereby enabling a loose coupling between the gate 24 and the frame 114.

For example, one or more first magnets 130 (magnet catch plate(s)) may be positioned on the frame 114 and one or more second magnets 132 may be positioned on each of the extensions 105 coupled to the second side 104. Each of the one or more second magnets 132 positioned on the extensions 105 of the second side 104 of the gate 24 may be configured to align with a corresponding first magnet 130 positioned on the frame 114 (e.g., align along the lateral axis 202 and the longitudinal axis 204) when the gate 24 is in the normal operating position such that the one or more first magnets 130 and the one or more second magnets 132 maintain a position of the gate 24 in the normal operating position (e.g., when no forces are acting on the gate 24 via engagement of a guest 16 or object associated with the guest 16 with the gate 24). However, as the pathway 12 directs guests 16 toward the exit point 20 (e.g., toward the gate 24 and/or the barrier 26), interaction with the gate 24 by a guest 16 (or component associated with the guest 16) may cause the magnets 130, 132 to disengage with one another, thereby enabling the gate 24 to rotate about the rotation position 116 (e.g., axis defined by the first side 102 (e.g., fixed axis), point (e.g., fixed point)) and transition to the disengaged position, as described above.

In certain embodiments, the gate 24 may include one or more sensors 30 configured to detect transitioning of the gate 24 from the normal operating position to the disengaged position. For example, at least one of the one or more sensors 30 may be mounted to the frame 114 and/or the gate 24 (e.g., mounted to the barrier 116 disposed across the opening 110 of the gate 24) and may be configured to detect engagement of a guest 16 or object associated with the guest 16 with the gate 24. For example, in certain embodiments, the one or more sensors 30 may be configured to detect whether the magnets 130 of the frame 114 and the magnets 132 of the gate 24 are engaged with one another. Upon detecting that the magnets 130 and the magnets 132 are disengaged from one another (e.g., via interaction of a guest 16 (or component associated with the guest 16) with the gate 24), the one or more sensors 30 may communicate such data to the controller 32, thereby enabling the controller 32 to slow and/or stop the pathway 12. In this way, guests 16 may depart from the pathway 12 in an easier manner relative to when the pathway 12 is in motion.

As another example, at least one or more of the one or more sensors 30 employed by the show-ride system 10 may be impact sensors (e.g., impact sensor net) disposed across the opening 110 (e.g., disposed on the barrier 116) and the sensors 30 may be configured to detect a force of an impact generated in response to a guest 16 and/or component associated with the guest 16 interacting with the gate 24. The controller 32 may be configured to control operation of the pathway 12 based on a magnitude of the force. For example, the controller 32 may be configured to reduce a speed of the pathway 12 by a first percentage (e.g., reduce speed by 25%) in response to the force of the impact being less than a first threshold value (e.g., less than 10 N) but greater than zero. Further, the controller 32 may be configured to reduce the speed of the pathway 12 by a second percentage (e.g., reduce speed by 75%) in response to the force of the impact exceeding the first threshold value but not exceeding a second threshold value (e.g., 35 N). Further still, the controller 32 may be configured to stop the pathway 12 in response to the force of the impact exceeding the second threshold value. Thus, the controller 32 may be configured to proportionally control a speed of the pathway 12 the pathway 12 based on a magnitude of the force detected by the one or more impact sensors 30, as described in greater detail below.

Additionally, the controller 32 may be configured to control a speed of the pathway 12 based on various other conditions. For example, as noted above, one or more of the sensors 30 may be distributed about the show-ride system 10, and may be configured to collect data indicative of one or more characteristics (e.g., movement or positioning) of a guest 16 on the pathway 12. Using the data from the sensors 30, the controller 32 may determine that a probability of a guest engaging with the gate 24 exceeds a predetermined threshold, and the controller 32 may be configured to slow and/or stop the pathway 12 based on the probability of the guest 16 engaging with the gate 24 exceeding the predetermined threshold. In this way, the controller 32 may proactively control the pathway 12 before a guest 16 engages with the gate 24, thereby reducing a likelihood that the guest 16 and/or component of the guest engages with the gate 24, as discussed in greater detail below.

In certain embodiments, the gate 24 may also be associated with a latch system 140 (e.g., latch mechanism, latch assembly, latch device) configured to maintain a position of the gate 24 in the disengaged position upon a guest 16 interacting with the gate 24. For example, the latch system 140 may be coupled to the frame 114 and may extend in a direction (e.g., horizontal direction) along the longitudinal axis 204 toward the barrier 26. In certain embodiments, the latch system 140 may be configured to engage with the extensions 105 of the second side 104 of the gate 24, and as the second side 104 of the gate 24 moves toward the barrier 26 (e.g., moves in a direction along the axis 118, moves in the direction of travel 28 of the pathway 12, rotates about the axis 116 defined by the first side 102 toward the barrier 26) via engagement of the gate 24 by a guest 16 (or object associated with the guest 16), the latch system 140 may block the gate 24 from moving in a direction 142 away from the barrier 26 (e.g., in a direction opposite to the direction of travel 28 of the pathway 12) and toward incoming guests 16 positioned along the pathway 12. In this way, upon a guest 16 engaging with the gate 24 to transition the gate 24 from the normal operating position to the disengaged position, the latch system 140 may block the gate 24 from rotating back on the guest 16, thereby enabling the guest to depart from the pathway 12.

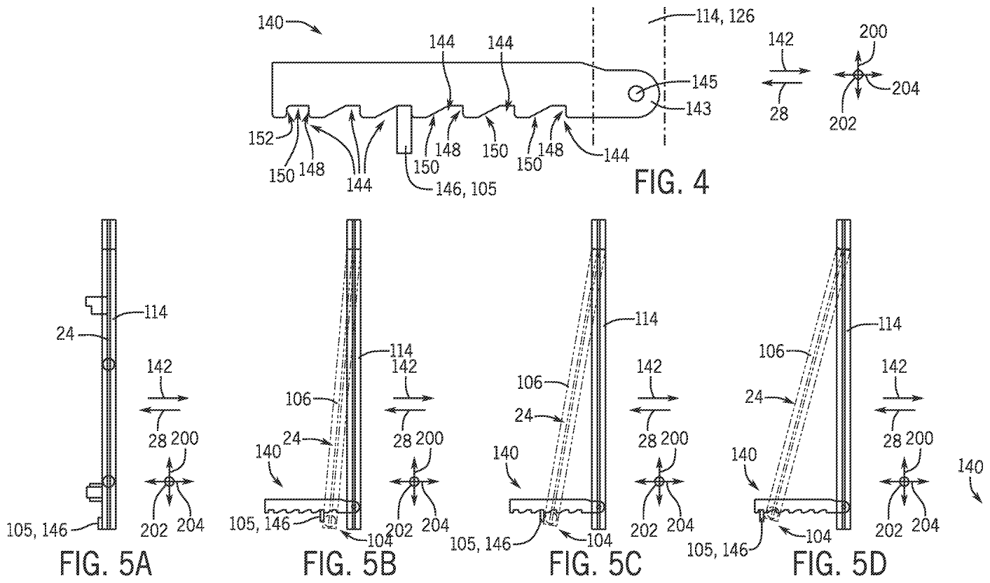

For example, FIG. 4 is a perspective view of an embodiment of the latch system 140 of FIG. 3 and FIGS. 5A, 5B, 5C, and 5D are side views of an embodiment of the latch system 140 as the gate 24 transitions from the normal operating position (as shown in FIG. 5A) to a fully disengaged position (as shown in FIG. 5D). In the illustrated embodiments, the latch system 140 includes a body 143 that defines a series of notches 144 and a passage 145. Each of the notches 144 may be configured to engage with a latch stop 146 (e.g., the extension 105) that is coupled to the second side 104 of the gate 24 to secure the gate 24 in a particular position. The passage 145 may be configured to receive a fastener, thereby enabling the latch system 140 to be coupled the gate 24.

As illustrated in FIG. 4, each of the notches 144 may include a first surface 148 (e.g., limiting surface) extending in a direction (e.g., vertical direction) along the vertical axis 200 of the gate 24 and a second surface 150 (e.g., angled surface) extending at an angle relative to the longitudinal axis 204 of the gate 24. The first surface 148 of each notch 144 may be configured to limit and/or block movement of the gate 24 in the direction 142 away from the barrier 26 (e.g., in a direction opposite to the direction of travel 28 of the pathway 12) and/or toward a guest and/or component of the guest 16 engaging with the gate 24 via interaction of the latch stop 146 with the first surface 148 of a respective notch 146. The second surface 150 of each notch 144 may be configured to enable the gate 24 to move in a direction toward the barrier 26 (e.g., move in the direction of travel 28 of the pathway 12). That is, as the gate 24 transitions from the normal operating position to the disengaged position (e.g., as the gate 24 moves toward the barrier 26 via engagement of a guest 16 and/or component of the guest 16 with the gate 24), the latch stop 146 may travel across the second surface 150 of a respective notch 144 before engaging with an adjacent notch 144 disposed downstream of a preceding notch 144 relative to the direction of travel 28 of the pathway 12.

In certain embodiments, the latch system 140 may enable the gate 24 to rotate about the rotation position (e.g., axis 116 defined by the first side 102 (e.g., fixed axis), point (e.g., fixed point)) by an angle of zero to fifteen degrees. For example, as the second side 104 of the gate 24 moves away from the frame 114 (e.g., moves in the direction of travel 28 of the pathway 12, moves toward the barrier 26), the latch stop 144 may engage with a first notch 144 (e.g., upstream notch relative to the direction of travel 28 of the pathway 12) of a plurality of notches 144 disposed on the latch system 140 such that the second side 104 of the gate 24 is moved away from the frame 114 by an angle of five degrees. As a guest 16 continues to travel through the gate 24, the second side 104 of the gate 24 may continue to move in the direction of travel 28 of the pathway 12 (e.g., move toward the barrier 26), and the latch stop 146 may engage with an intermediate notch 144 disposed downstream of the first notch 144 relative to the direction of travel 28 of the pathway 12 such that the second side 104 of the gate 24 is moved away from the frame 114 by an angle of ten degrees. Further still, as the second side 104 of the gate 24 continues to move toward the barrier 26, the latch stop 146 may engage with a final notch 144 disposed downstream of the first notch 144 and the intermediate notch 144 relative to the direction of travel 28 of the pathway 12 such that the second side 104 of the gate 24 is moved away from the frame 114 by an angle of fifteen degrees.

As illustrated in FIG. 4, in certain embodiments, the second surface 150 of the final notch 146 (e.g., most downstream notch 146 relative to the direction of travel 28 of the pathway 12) may not be an angled surface, and instead, the second surface 150 of the final notch 144 may extend in a direction (e.g., horizontal direction) along the longitudinal axis 204. Accordingly, the final notch 144 may include a third surface 152 extending in a direction (e.g., vertical direction) along the vertical axis 200 of the gate 24, such that the gate 24 is blocked from traveling beyond the final notch 144 via interaction of the latch stop 146 with the third surface 152. In this way, movement of the gate 24 may be limited, thereby enabling the gate 24 to block the guests 16 from traveling beyond the gate 24 or further downstream along a direction of travel (e.g., toward and/or into the barrier 26). It should be appreciated that the angles above are not intended to be limiting, and in certain embodiments, the latch system 140 may enable the gate 24 to rotate by an angle greater than or less than those described above.

Additionally, in certain embodiments, a maximum distance and/or angle that the second side 104 of the gate 24 may travel may be based on certain operating parameters of the pathway 12. For example, as noted above, upon detecting that the gate 24 is transitioning from the normal operating position to the disengaged position, the one or more sensors 30 may send one or more signals to the controller 32 indicative of the gate transitioning. Based on the signal(s) received by the sensors 30, the controller 32 may send instructions to stop the pathway 12 via a signal. However, a delay may be associated with the signal transmission such that the pathway 12 may continue to move after a guest 16 engages with the gate 24. Thus, the latch system 140 may be configured to enable the guest 16 to move along with the second side 104 of the gate 24 for a predetermined distance to account for the delay.

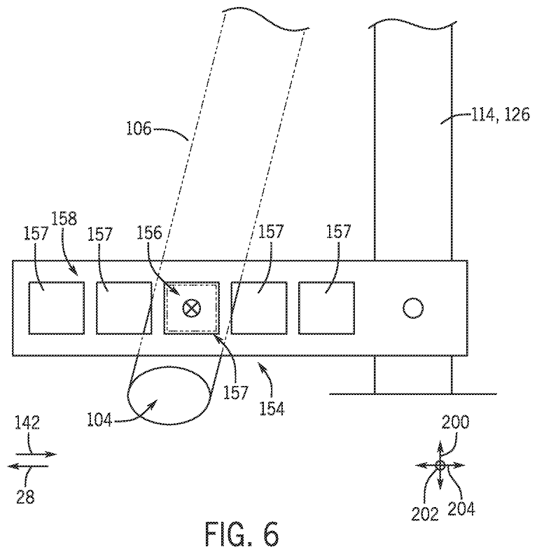

It should be appreciated that the examples described herein are not intended to be limiting and in certain embodiments, the various features described above may be located in different positions without departing from the scope of this application. Additionally, in certain embodiments, the gate 24 may include additional features configured to perform the techniques described herein. For example, in certain embodiments, the latch system 140 described above may be replaced by one or more magnets arranged in series, and the one or more magnets may be configured to limit movement of the gate 24 in a direction toward the guest 16 (e.g., in the direction 142 opposite the direction of travel 28 of the pathway 12). For example, FIG. 6 illustrates an embodiment of the show-ride system 10 in which a magnet system 154 (e.g., magnet latch system) is utilized to maintain a position of the gate 24 in the disengaged position upon a guest 16 interacting with the gate 24.

In the illustrated embodiment, the magnet system 154 includes a first magnet 156 positioned on the gate 24 at a junction between the second side 104 and the third side 106 of the gate 54, and the first magnet 156 may be configured to interact with (e.g., magnetically couple to) one or more magnets 157 of a magnet assembly 158 coupled to the frame 114. For example, the magnet assembly 158 may include a series of magnets 157 that successively extend away from the frame 114 in the direction of travel 28 along the longitudinal axis 204 toward the barrier 26. Each of the magnets 157 may be configured to align with the magnet 156 of the gate 54 along the lateral axis 202 of the gate 54 as the gate transitions from the normal operating position to the disengaged position (e.g., as the gate 24 moves toward the barrier 26).

For example, as a guest 16 and/or component associated with the guest 16 engages with the gate 24 while traveling in the direction of travel 28 of the pathway 12, the first magnet 156 positioned on the gate 24 (e.g., positioned at the junction between the second side 104 and the third side 106) may move toward a first magnet 157 disposed on the magnet assembly 158, thereby enabling the magnet 156 to couple to the first magnet 157 (e.g., upstream magnet relative to the direction of travel 28 of the pathway 12) to block the gate 24 from traveling back toward the guest 16 (e.g., blocking the gate from traveling in the direction 142). As the guest 16 continues to travel through the gate 24, the force generated against the gate 24 may cause the magnet 156 coupled to the gate 24 to disengage from the first magnet 157 of the magnet assembly 158, thereby enabling the gate 24 to continue moving toward the barrier 26. In turn, the magnet 156 of the gate 24 may engage with a second magnet 157 (e.g., intermediate magnet relative to the direction of travel 28 of the pathway 12) in the magnet assembly 158 that is disposed downstream of the first magnet 157 of the magnet assembly 158 relative to the direction of travel 28 of the pathway 12. In this way, interaction (e.g., magnetic engagement) between the magnet 156 of the gate 24 and the second magnet 157 of the magnet assembly 158 may block the gate 24 from traveling back toward the guest 16.

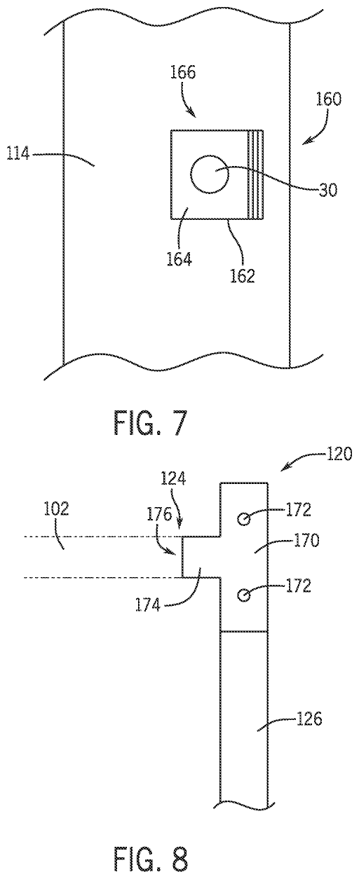

As noted above, in certain embodiments, the one or more sensors 30 may be mounted to components of the ride-show system 10 via a sensor mounting plate. For example, FIG. 7 is a perspective view of an embodiment of a sensor mounting plate 160 that may be employed by the ride-show system 10 to mount the sensors 30 to components of the ride-show system 10 (e.g., mount the sensor 30 to the frame 114, mount the sensor 30 to the gate 24). In the illustrated embodiment, the sensor mounting plate 160 includes a body 162 that defines a first surface 164 (e.g., front surface, upstream surface) and a second surface 166 (e.g., rear surface, downstream surface). In certain embodiments, the first surface 164, the second surface 166, or both may be configured to receive a sensor 30. That is, a sensor 30 may be mounted to either the first surface 164, the second surface 166, or both the first and second surfaces 164, 166. In the illustrated embodiment, the sensor mounting plate 160 is mounted (e.g., coupled) to the frame 114. However, in certain embodiments, additional sensor mounting plates 160 may be coupled to the gate 24 and/or other components of the show-ride system 10, thereby enabling the sensors 30 disposed thereon to collect data indicative of a guest 16 interacting and/or engaging with the gate 24. For example, in certain embodiments, a first sensor mounting plate 160 may be coupled (e.g., mounted via fasteners, welding, adhesives) to the gate 24 (e.g., coupled to a side 102, 104, 106, 108 of the gate 24) and a second sensor mounting plate 160 may be coupled to the frame 114. A sensor 30 may then be mounted to each of the sensor mounting plates 160 (e.g., via an adhesive, via a fastener), thereby enabling the sensors 30 to detect interaction and/or engagement of a guest 16 and/or component associated with the guest 16 with the gate 24 (e.g., detect transitioning of the gate 24 from the normal operating position to the disengaged position).

FIG. 8 is a perspective view of an embodiment of the mounting bracket 120 of FIG. 2. As noted above, the gate 24 may employ one or more mounting brackets 120 to couple the gate 24 to the frame 114. In the illustrated embodiment, the mounting bracket 120 includes a base 170 that defines one or more passages 172 configured to receive one or more fasteners to couple the mounting bracket 120 to the frame 114 (e.g., couple the mounting bracket 120 to the support 126 of the frame 114). Additionally, the mounting bracket 120 may include a protrusion 174 extending from the base 170 and configured to receive a respective first end 122 or second end 124 of the first side 102 of the gate 24. For example, in the illustrated embodiment, the protrusion 174 defines a cavity 176 configured to receive the second end 124 of the first side 102. The cavity 176 may have a geometry that aligns with a geometry of a respective end (e.g., the second end 124) of the first side 102 of the gate 24, thereby enabling the gate 24 to rotate about the rotation position 116 (e.g., axis defined by the first side 102).

FIG. 8 illustrates an embodiment of a method 300 that may be utilized to control operation of the show-ride system 10. In particular, the method 300 may be implemented to facilitate departure of a guest 16 from the pathway 12. For example, the controller 32 (e.g., control system, the processing circuitry 34) may be configured to implement and/or execute the method 300 to control various components of the show-ride system 10 (e.g., control operation (e.g., a speed) of the pathway 12, control operation of the show-ride entertainment 22). In other embodiments, the method 300 may be implemented by another controller, more than one controller, or other suitable control system. It should also be appreciated that additional steps may be performed with respect to the method 300. Moreover, certain steps of the depicted method 300 may be removed, modified, and/or performed in a different order.

As mentioned above, the method 300 may be implemented to control aspects of the show-ride system 10. For example, the method 300 may be implemented to determine whether to reduce a speed of the pathway 12 and/or how much to reduce a speed of the pathway 12 to facilitate guests departing from the pathway 12. Though the method 300 is illustrated as a series of steps, it should be understood that the method 300 may be executed or implemented as a continual or continuous loop based on any suitable input, data, or feedback (e.g., feedback from the one or more sensors 30). That is, the steps of the method 300 may be repeatedly executed (e.g., in a sequential order) to enable evaluation of a speed at which to operate the pathway 12 (e.g., based on guest interaction and/or potential guest interaction with the gate 24). Indeed, the method 300 may be continually or continuously executed to dynamically control components of the show-ride system 10 in real time. In some embodiments, one or more steps of the method 300 may be executed or performed simultaneously.

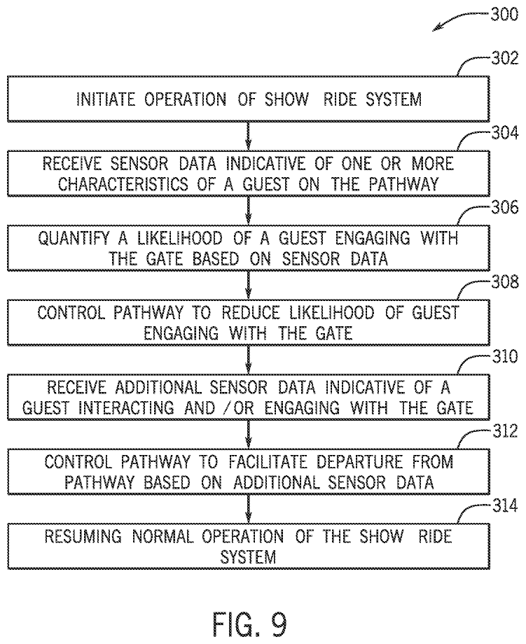

Referring now to FIG. 9, the controller 32, at block 302, may initiate operation of the show-ride system 10 to transport guests 16 from the entry point 18 to the exit point 20. For example, the controller 32 may receive an instruction from an operator to initiate operation of the show-ride system 10 (e.g., operate the pathway 12 to move at a desired target speed), thereby enabling the pathway 12 to transport guests 16 through the show-ride system 10. Additionally, at block 302, the instruction from the operator may cause the controller 32 to present feedback (e.g., audio, haptic, visual feedback) to the guests 16 disposed along the pathway 12 via the show action equipment 22. That is, upon initiating operation of the show-ride system 10, the controller 32 may control the show action equipment 22 and the pathway 12 to provide guests with an immersive experience.

As the pathway 12 transports guests 16 from the entry point 18 to the exit point 20, the controller 32, at block 304, may receive data from the one or more sensors 30 disposed about the show-ride system 10. As noted above, the sensor data generated by one or more of the one or more sensors 30 may be indicative of one or more characteristics of the guests 16 (e.g., physical characteristic of guest (e.g., health, age, gender), components associated with the guest 16, one or more hazards associated with the guest 16, a behavior of a guest 16) disposed along the pathway 12. As a specific example, the sensor data may indicate movement of the guest, a posture of the guest, and/or a location of the guest, including a direction in which the guest is looking, all of which may be utilized by the controller 32 to predict how the guest will likely interface with the gate 24 and/or the barrier 26.

At block 306, using one or more algorithms (e.g., machine learning and/or artificial intelligence models), the controller 32 may quantify a likelihood (e.g., probability) of a particular guest 16 engaging with and/or interacting with the gate 24. For example, using data from the sensors 30, the controller 32 may determine that a particular guest 16 has an age over a threshold value (e.g., 65 years), and thus may quantify the likelihood of the guest engaging with the gate 24 at fifty percent likely. As another example, using data from the sensors 30, the controller 32 may determine that a particular guest 16 has a shoe that is untied, and thus may quantify the likelihood of the guest engaging with the gate 24 at forty percent likely. In yet another example, using the data from the sensors 30, the controller 32 may determine that one or more guests 16 are engaging in behavior (e.g., horse playing) that has a high likelihood of causing the guests 16 to engage with the gate 24.

Using the data from the sensors 30 indicative of a likelihood of a particular guest engaging with the gate 24, the controller 32, at block 308, may control the pathway 12 to reduce a likelihood of the guest(s) 16 engaging with the gate 16. For example, in response to determining that the likelihood of a guest 16 engaging with the gate 24 is greater than a pre-defined threshold value, the controller 32 may proportionally reduce a speed of the pathway 12 once the guest is within a threshold distance of the gate 24, thereby reducing the likelihood that the guest 16 engages with the gate 24. In certain embodiments, the controller 32 may be configured to proportionally control the speed of the pathway 12 based on the likelihood of a guest 16 engaging with the gate 24. For example, as the likelihood of a guest 16 engaging with the gate 24 increases, the controller 32 may correspondingly decrease a speed of the pathway 12 by a greater magnitude. In certain embodiments, based on the likelihood of the guest 16 engaging with the gate 24 being imminent (e.g., 90% likely, 95% likely, 100% likely), the controller 32 may stop and/or halt the pathway 12, thereby reducing the likelihood that the guest 16 engages with the gate 24.

As the pathway 12 transports guests 16 along the pre-defined path 14 from the entry point 18 to the exit point 20, the controller 32, at block 310, may receive additional data from one or more sensors 30 disposed proximate the gate 24 (e.g., coupled to the gate 24, coupled to the frame 114, positioned within a threshold distance of the gate 24). As noted above, one or more of the sensors 30 described above may be configured to collect data indicative of a guest engaging and/or interacting with the gate 24. Accordingly, the additional sensor data may correspond to data that is indicative of a guest 16 and/or component associated with the guest 16 engaging with the gate 24. For example, in certain embodiments, the one or more sensors 30 may be motion sensors or proximity switches configured to detect movement of the gate 24 away from the frame 114 (e.g., detect movement of the second side 104 of the gate 24 away from the frame 114) as a result of a guest 16 and/or component of the guest 16 engaging with the gate 24. Additionally or alternatively, the one or more sensors 30 may be configured to detect when the magnets 130, 132, are disengaged from one another (e.g., in response to a guest and/or component of the guest 16 interacting with the gate 24). Further still, the one or more sensors 30 may be impact sensors configured to detect a force of impact against the gate 24 (e.g., in response to a guest and/or component of the guest 16 interacting with the gate 24).

Using the additional data from the sensors 30 disposed proximate the gate 24, the controller 32, at block 312, may control the pathway 12 to facilitate guests 16 departing from the pathway 12. For example, upon detecting that the gate 24 has transitioned from the normal operating position to the disengaged position (e.g., upon detecting that the magnets 130, 132 are no longer engaged with one another, upon detecting that the gate 24 has moved from the normal operating position, upon detecting a force of an impact against the gate 24), the controller 32 may send a signal to slow and/or stop the pathway 12, thereby enabling guests 16 to depart from the pathway 12 in an easier manner relative to when the pathway 12 is in motion. In certain embodiments, the controller 32 may employ one or more algorithms and/or machine learning to control a speed of the pathway 12 in response to detecting that the gate 24 is transitioning from the normal operating position to the disengaged position. In certain embodiments, the controller 32 may be configured to determine a magnitude of a force of impact against the gate 24, and may proportionally control a speed of the pathway 12 based on the magnitude of the force of impact. For example, upon detecting that a force of impact is less than a first threshold value but greater than zero, the controller 32 may decrease a speed of the pathway 12 by 25 percent. Upon detecting that the force of the impact is greater than the first threshold value but less than a second threshold value, the controller 32 may decrease a speed of the pathway 12 by 75 percent. Further still, upon detecting that the force of the impact is greater than the second threshold value, the controller 32 may stop the pathway 12. Thus, the controller 32 may proportionally control a speed of the pathway 12 based on a magnitude of the force of impact against the gate 24. In this way, the controller 32 may avoid unnecessary reductions in speed and/or stops, thereby improving an experience of the guest 16 using the show-ride system 10.

Upon determining that the guest 16 is no longer engaged with the gate 24 (e.g., upon determining that the guest 16 has successfully departed from the pathway 12), the controller 32, at block 314, may resume normal operation of the show-ride system 10. That is, the controller 32 may instruct the gate 24 (instruct an operator associated with the gate 24) to return to the normal operating position, and may instruct the pathway 12 to operate at a desired speed to transport guests 16 from the entry point 18 to the exit point 20.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

1. A show-ride attraction, comprising:
a moving pathway configured to transport a guest toward a barrier;
a gate positioned across the moving pathway upstream of the barrier relative to a direction of travel of the moving pathway, wherein the gate is configured to transition between a first position and a second position in response to the guest engaging with the gate;
one or more sensors configured to detect transitioning of the gate from the first position to the second position; and
a controller configured to control the moving pathway in response to an indication from the one or more sensors that the gate is transitioning and/or has transitioned to the second position.

2. The show-ride attraction of claim 1, comprising a frame, wherein the first position corresponds to a normal operating position of the gate loosely coupled to the frame, and the second position corresponds to a disengaged position of the gate disengaged from the frame.

3. The show-ride attraction of claim 2, wherein the gate is loosely coupled to the frame in the normal operating position via one or more magnets.

4. The show-ride attraction of claim 3, wherein a first magnet of the one or more magnets is coupled to the gate, and a second magnet of the one or more magnets is coupled to the frame, and wherein the first magnet and the second magnet are configured to align with one another and configured to magnetically couple to one another in the normal operating position of the gate.

5. The show-ride attraction of claim 2, wherein the gate comprises:
a first side rotatably coupled to the frame; and
a second side configured to move in the direction of travel of the moving pathway relative to the frame.

6. The show-ride attraction of claim 5, comprising a latch system configured to engage with the second side during transitioning to the second position or in the second position to maintain a position of the gate in the disengaged position.

7. The show-ride attraction of claim 6, wherein the latch system extends from the frame in a direction along a longitudinal axis of the gate, and wherein the latch system comprises a body defining one or more notches.

8. The show-ride attraction of claim 7, wherein the second side of the gate comprises an extension configured to engage with the one or more notches of the latch system to maintain the position of the gate in the disengaged position.

9. The show-ride attraction of claim 1, wherein the gate comprises:
a plurality of sides;
an opening defined by the plurality of sides; and
an additional barrier extending across the opening and configured to limit movement of the guest beyond the gate.

10. The show-ride attraction of claim 9, wherein at least one of the one or more sensors is an impact sensor configured to detect a force of impact against the gate, wherein the impact sensor is disposed on the additional barrier extending across the opening.

11. The show-ride attraction of claim 10, wherein the additional barrier comprises a net extending across the opening.

12. The show-ride attraction of claim 1, wherein the controller is configured to reduce the speed of the moving pathway in response to the signal indicative of the gate transitioning to the second position.

13. The show-ride attraction of claim 1, wherein the controller is configured to stop the moving pathway in response to the signal indicative of the gate transitioning to the second position.

14. A non-transitory, computer-readable medium comprising computer-executable instructions that, when executed by processing circuitry, cause the processing circuitry to:
operate a moving pathway at a first speed to transport guests from an entry point of a ride-show attraction to an exit point of the ride-show attraction;
receive sensor data from one or more sensors positioned about the ride-show attraction, wherein the sensor data is indicative of a gate of the ride-show attraction transitioning from a first position to a second position; and
operate the moving pathway at a second speed to facilitate departure of a guest from the moving pathway based on the sensor data indicating that the gate is in the second position.

15. The non-transitory, computer-readable medium of claim 12, wherein the second speed is less than the first speed.

16. The non-transitory, computer-readable medium of claim 12, wherein the first position corresponds to a normal operating position, and wherein the second position corresponds to a disengaged position.

17. The non-transitory, computer-readable medium of claim 12, wherein the instructions, when executed by the processing circuitry, cause the processing circuitry to operate show-ride entertainment positioned along the moving pathway to provide an immersive experience for the guest on the pathway.

18. A method for controlling operation of a moving pathway of a show-ride attraction, the method comprising:
initiating operation of the moving pathway to transport one or more guests from an entry point of the show-ride attraction to an exit point of the show-ride attraction;
receiving sensor data from one or more sensors, wherein the sensor data is indicative of at least one of the one or more guests interacting with a gate extending across the moving pathway such that the gate transitions from a first position to a second position; and
controlling a speed of the moving pathway based on the sensor data indicating that the gate is in the second position.

19. The method of claim 18, comprising:
receiving additional sensor data from one or more additional sensors, wherein the additional sensor data is indicative of one or more characteristics of the one or more guests positioned along the moving pathway;
analyzing the additional sensor data to quantify a probability of a guest of the one or more guests interacting with the gate; and
controlling the speed of the moving pathway based on the additional sensor data indicating that the probability of the guest interacting with the gate exceeds a predetermined threshold probability.

20. The method of claim 19, wherein the one or more characteristics correspond to a behavior of the one or more guests, an age of the one or more guests, a health level of the one or more guests, one or more components associated with the one or more guests, a hazard level of the one or more guests, or any combination thereof.
